(19) United States
(12) Patent Application Publication
(10) Pub. No.: US 2009/0035869 A1
(43) Pub. Date: Feb. 5, 2009

(54) METHOD AND SYSTEM FOR GENETIC PATTERN RECOGNITION

(75) Inventor: Nicola Scuor, Gradisca D'Isonzo (IT)

Correspondence Address: GIFFORD, KRASS, SPRINKLE,ANDERSON & CITKOWSKI, P.C, PO BOX 7021, TROY, MI, 48007-7021, US

(73) Assignee: UNIVERSITA DEGLI STUDI DI TRIESTE

(21) Appl. No.: 12/096,634

(22) PCT Filed: Dec. 13, 2006
(86) PCT No.: PCT/EP2006/069659

§ 371 Date: Jun. 9, 2008

(30) Foreign Application Priority Data
Dec. 14, 2005 (IT) PD2005A000365

(51) Int. Cl. G01N 27/00

(52) U.S. Cl. 436/94; 422/82.01

(57) ABSTRACT

A method and an system for the detection of nucleic acid oligonucleotides is characterized in that said detection corresponds to a capacitive reading of the melting point of complexes obtained by hybridization of said oligonucleotides and suitably modified molecules of oligonucleotide probes.

### FIELD OF THE INVENTION

The present invention relates to a method and a system for genetic pattern recognition and more specifically to a method and a system for recognition of genetic patterns for identification of point mutations in genomic DNA, or SNPs (Single Nucleotide Polimorphisms).

### STATE OF THE ART

It is well known that, in the field of analysis of genetic patterns, there is high interest for monitoring the presence in human or animal DNA of genetic defects that are correlated with or predisposing to the development of certain pathologies. Moreover, the analysis of genetic patterns is also of interest for the nutritional field, particularly for detection of toxin-producing bacteria, as well as for controls on GMO (animal and plant).

Furthermore, this type of genetic pattern analysis is presently applied also to the search for pathogenic agents in soil, water, etc.

At last, genetic pattern analysis is used also in the field of forensic medicine.

Up to now, the above applications make use of commercially available systems of analysis based on labelling the relevant molecule/molecules after analysis of such molecules according to a method already well known in the art.

This practice represents the first disadvantage because is expensive and time consuming, since it involves specialized non-in-house laboratories that require specialized personnel in order to carry out such analysis and evaluate the results. Moreover, another disadvantage of this type of analysis is the typical requirement for optical titration systems or equivalent systems, that are too slow, complex and expensive.

A further disadvantage of the above method derives from the need to protect the environment from interfering factors during the analysis of said molecules, because this type of analysis is typically sensitive to such interfering factors.

Therefore, the aim of the present invention is to provide a method and a system for genetic pattern recognition that definitively solves the above-mentioned disadvantages since it does not involve labeling of the molecules to be analyzed.

Another aim of the present invention is to provide a methodology and a system for genetic pattern recognition not involving mobile parts or components for the analysis, but fully composed of solid/immobile components.

A further aim of the present invention is to provide a methodology and a system for genetic pattern recognition based on the application of electrical phenomena and not involving optical titration systems or equivalent systems.

Another aim of the present invention is to provide a methodology and a system for genetic pattern recognition that is highly sensitive, reliable and robust against the interference of environmental factors, that does not involve the necessity to employ specialized personnel in order to carry out the analyses and the evaluation of results.

A further aim of the present invention is to provide rapid, versatile and inexpensive methodology and system for genetic pattern recognition.

### SUMMARY

The present invention provides a methodology for genetic pattern recognition according to claim 1. Furthermore, the present invention provides a system for analysis of genetic patterns according to claim 20.

The methodology and the system of the present invention have several advantages. A first advantage is in the possibility to carry out the analysis of genetic patterns with high sensitivity, reliability and low cost.

Another advantage of the system is in its simplicity and convenience of use, remarkable capacity to reject environmental noise (thermal, mechanical, electrical) and operating flexibility.

### BRIEF DESCRIPTION OF THE FIGURES

A detailed description of a preferred embodiment of the genetic pattern recognition methodology and system of the present invention will be now provided, given as a non limiting example, and with reference to the enclosed drawings, wherein:

FIG. 1 shows a first electrical diagram of the genetic pattern recognition system, according to the present invention;

FIG. 2 shows a second electrical diagram of the genetic pattern recognition system, according to the present invention;

FIG. 3 shows a third electrical diagram of the genetic pattern recognition system, according to the present invention;

FIGS. 4A and 4B show schematically the structure of a first device of the genetic pattern recognition system, according to the present invention;

FIG. 5 shows a form of embodiment of the first device of the genetic pattern recognition system, according to the present invention;

FIG. 6 shows the details of a part of the device in FIG. 5;

FIGS. 7A and 7B show a partial perspective view of a second device of the genetic pattern recognition system, according to the present invention;

FIG. 8 shows a functioning arrangement of the second device of the system of the present invention;

FIGS. from 9A to 9E show an operational sequence for the functioning of the system of the present invention;

FIG. 10 shows the diagram of a first analytical function, according to the system of the present invention; and

FIG. 11 shows the diagram of a second analytical function, according to the system of the present invention.

### DETAILED DESCRIPTION OF THE INVENTION

At first, the functioning of the system of the present invention will be now explained with reference to the enclosed figures.

The system functioning is based on a detection method, carried out by capacitive reading of the melting point, induced by means of an electrical field, of the complexes between the DNA-analite and suitably modified oligonucleotides.

For this, the system involves a special microfluidic cell realized in such a way that it makes possible to carry out analyses according to this technique.

The denaturing cell is designed to carry out the following functions:
Application of an electrical field for control of hybridization and denaturation reactions done with unknown DNA sequences in solution and oligonucleotides immobilized on one of the inner surfaces of the cell.
Continuous evaluation of the advancement of reactions by capacitive reading.
   At the same time, the system must be able to ensure the following features:
Absence of electrolytic reactions on the electrode surface, such as the release of ions in solution and the formation of gas bubbles.
Uniformity of the electrical fields present.
Low working voltage values.
Simultaneous and independent functioning of the systems for application of the electrical field and for capacitive reading.

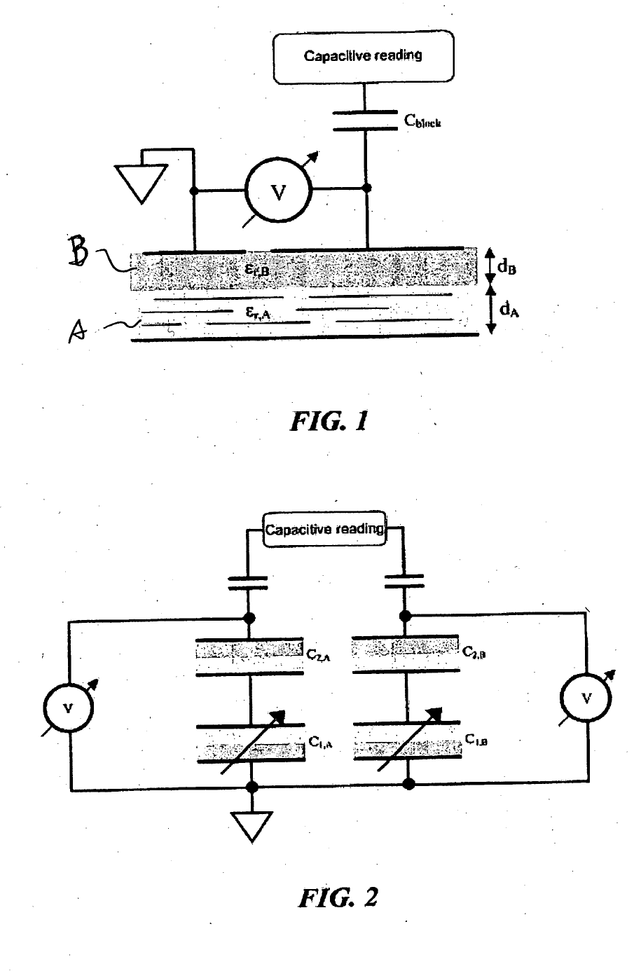

The structure of the so realized denaturing cell is schematically shown in FIG. 1.

As it is possible to note in the figure, the dielectric A represents the working solution, consisting of an aqueous buffer containing the unknown nucleic acid sequences. It can be assumed that the value of the relative dielectric constant ∈_{r,A} is equal to that of water, that is about 80. The lower cell wall is coated, on the side in contact with the solution, with a gold layer, of thickness approximately ranging between 5 and 20 nm, laid on an insulating material of polymeric or ceramic type.

This is functionalized by synthetic oligonucleotides arranged in a SAM (Self Assembled Monolayer) structure. The structure of the oligonucleotides used comprises a number of bases generally ranging between 10 and 100 and the presence, at the 3′ or 5′ terminus, of a C₆ spacer group linked to a thiol group. This enables oligonucleotide immobilization on the active surface of the cell, through the formation of gold-sulfur covalent bonds. The sequence of the bases composing the oligonucleotides, the possible presence and arrangement of modified bases (LNA, PNA, etc.) and the possible modification of the free terminus depend on the specific application.

The presence of the dielectric B makes possible to avoid the development of electrolytic reactions, preventing the circulation of currents even in presence of continuous polarization voltages applied by means of the generator V. Insulating materials of ceramic or polymeric type can be used for this purpose. The electrodes present on the upper wall of the cell, although electrically insulated from the working solution, make possible to run the reactions of electrically assisted hybridization and denaturation promoted by the electrostatic field and the electrophoretic transport of DNA chains. The structure of the cell is characterized by the presence of a single electrode on the lower wall and of two contiguous and physically distinct electrodes on the upper wall. The former is characterized by a shape and a size such that it occupies at least the area corresponding to the projection of the latter ones. The condenser C_{block} makes possible to decouple the working cell from the capacity reading system with respect to the continuous voltage component. This allows to establish the static or slowly variable potential that is required to promote the denaturation reaction (offset) and to perform a simultaneous reading of the capacity of the system by techniques based on analysis of the circuit response to voltage variations. Therefore, system optimization can be carried out acting on two factors:
a) Choice of material with a high value of the relative dielectric constant ∈_{r,B} for realization of layer B of the denaturing cell. In addition to electrical insulation, such material should ensure a complete impermeability towards the fluid even for prolonged exposures, chemical inertia towards the working solutions, easy workability and availability, and a low cost. A class of materials able to meet these requirements can be identified in piezoelectric ceramics, especially those with perovskitic structure. The values of the dielectric constant characteristic for such materials are approximately comprised between 1000 and 20000, depending on class and composition. For instance, considering the use of the type 856 material produced by APC International Ltd., having a ∈ᵣ=4100, it can be estimated a value higher than 50 for the ratio ∈_{r,B}/∈_{r,A}. In comparison, the use for the same application of conventional polymeric material, easily available on the market, or of vitreous materials would involve values of the ∈_{r,B}/∈_{r,A} ratio that are typically not higher than 0.1.
b) Maximization of the ratio d_{A}/d_{B} between the thickness of the two dielectrics, also considering that it is preferable that the total thickness of the cell, equal to d_{A}+d_{B}, is as smaller as possible in order to keep the working voltage within acceptable limits. From a practical point of view, the minimum thickness d_{A} of the microfluidic section that can be realized with low-cost mechanical systems for mutual positioning of the cell walls, can be estimated to be 0.2+0.5 mm. Such thickness makes possible a rapid replacement of the functionalized surface. The use of ceramic materials indicated in point 1 for realization of the dielectric layer B involves, for reasons of workability, the adoption of a minimal thickness d_{B} of about 0.2 mm. In said conditions, the ratio d_{A}/d_{B} turns out to be comprised between 1 and 2.

The block condenser C_{block}, placed between the working cell and the system for measurement of the capacity, acts as de-coupling element between these two components relative to the continuous voltage component. The latter is present at the ends of the microfluidic cell, since it is applied by the generator V, to promote hybridization and denaturation reactions through the effect of the electrical field. From an electrical point of view, the component C_{block} can be viewed as an additional condenser placed in series with the measuring cell: thus the above-mentioned dimensioning criteria apply. In particular, use of the highest possible capacity value is convenient, compatibly with device miniaturization and cost demands. An indicative criterion consists in choosing for C_{block} a capacity equal to at least 20 fold that of the condenser C₁. This way, it is possible to obtain a good sensitivity of the system, corresponding to at least 90% of the theoretical maximal sensitivity.

On the other hand, some factors can affect reading of the parameters of the denaturing cell, in particular:
Changes of the temperature in the working environment.
Vibrations induced by external sources of mechanical noise.
Changes of the dielectric constant relative to the materials used for construction of the cell, due to the electrical fields applied.
Polarization and/or migration of molecules inside the working fluid and in proximity of the functionalized surface.

Such errors can be automatically corrected by using a differential reading system according to FIG. 2.

The proposed technique consists in reading the difference of capacity between

$$S = \frac{{C}_{1 , A} - {C}_{1 , B}}{{C}_{1 , A} + {C}_{1 , B}} ,$$

two denaturing cells having nominally identical geometric characteristics but functionalized in different ways: this way, the effects of the phenomena listed can be made negligible with no need to intervene on electronic correction systems or software. Indeed, in such a system, a non-null value of the normalized differential output signal S, represented by:
turns out to be essentially due to the different behaviour of the target molecules present in solution compared to the two types of molecular probes immobilized on the pair of active surfaces. As an example, it is possible to use molecular probes complementary to a specific sequence, the presence of which needs to be verified, for surface A and, vice versa, to functionalize surface B with substantially different molecular probes. In another case, to detect the presence of point mutations (SNPs), it is possible to use the same molecular probes for functionalization of both surfaces and to change, by substitution with a modified base (LNA, PNA, etc.), only the molecular probe on surface A, in a position corresponding to the sequence of bases under study.

Since it can automatically offset common mode effects, the system described essentially makes possible to improve the signal-to-noise ratio of the measuring device, thereby increasing the sensitivity of the system. This can be obtained easily, with good approximation, by using lithographic techniques to realize the system. Any little difference of capacity due to manufacturing tolerance, can be set to zero by the software without compromising the dynamics of response of the capacity reading system.

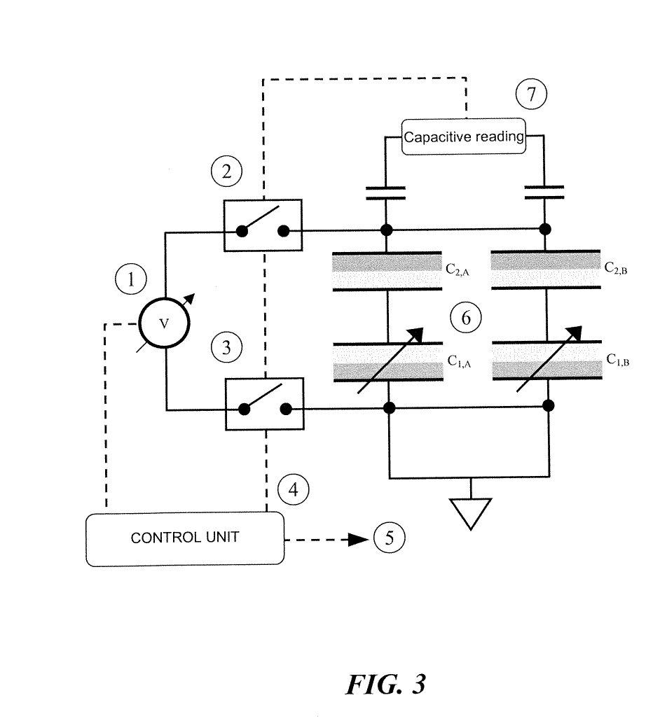

With reference to FIG. 3, this illustrates an additional electrical diagram relative to one form of embodiment of the denaturing cell. The capacity reading system, since it operates in differential mode, uses for the measurement frequencies approximately comprised between 10 kHz and 250 kHz. Any alternating system can be used for this purpose, so that it operates concomitantly with the continuous or slowly variable voltage generator to promote hybridization and denaturation reactions and electrophoretic transport inside the microfluidic cell. If it is advisable to use a floating measuring system (non-earth referenced), it is possible to insert in the measurement network an additional condenser that is dimensioned according to the same criteria exposed above.

The voltage generator used to promote hybridization and denaturation reactions and the electrophoretic transport inside the microfluidic cell should have very high impedance values relative to the signals used to measure capacity, in order not to degrade or make impossible this process. For instance, at the time of measurement, it is possible to isolate the voltage generator from condensers C₁ and C₂ by use of electronic switches based on FET devices (for instance by using integrated devices such as CD4046 or similar devices).

According to this embodiment, a denaturing cell 6 has a generator of variable voltage 1, two switches 2 and 3, and a system for measurement of the differential capacity 7 realized according to what has been described above. These components are operated by a control unit 4. The switches 2 and 3 can be realized with circuits based on the use of solid-state devices (FET). The voltage generator 1 can be realized by a digital-analogic converter that can be easily interfaced with the control unit 4. The latter typically consists of a digital microcontroller or microprocessor type of device, which is able to manage the communication with the other modules of the system through a communication bus 5. In order to minimize the noise introduced in the reading system, the control unit can be galvanically isolated from the controlled components 2, 3 and 7 by optoisolators or similar systems.

A complete analysis consists of sequential reading cycles, each composed by the following steps:
1. In the initial state, switches 2 and 3 are open.
2. The control system 4 sets the voltage of the generator 1 to the intended value.
3. Switches 2 and 3 are closed, waiting for the microfluidic cell condensers 6 to reach the voltage value set by the generator 1.
4. Opening of switches 2 e 3.
5. The control system 4 operates the differential measurement of capacity.
6. After data detection, the switches 2 and 3 are closed.
7. The process is repeated starting from step 2.

An advantage of the system described above is that, during the measurement of capacity, the electrical noise introduced in the system by generator 1 is automatically removed due to the galvanic isolation by switches 2 and 3. The use of two switches rather than one makes possible to reduce the parasitic capacity, introduced by the elements 2, 1 and 3 connected in series, that tends to act as bypass on cell 6 to which it is connected in parallel.

Alternatively, an element having high impedance at typical operating frequency of the capacity reading system can be put in series with the voltage generator 1, for instance RC or RL type low-pass filters. However, in this case, the time required for stabilization of the voltage at the ends of the microfluidic cell to the equilibrium value set by generator 1, turns out to be relatively long, thus requiring longer time for completion of the analysis.

The previously described measurement cell is especially advantageous, since there is no need to establish any connection by electromechanical devices inside the microfluidic cell. This result is achieved without affecting sensitivity of the capacity measurement system, making possible to improve device reliability, to reduce wearing and to preserve operative characteristics unaltered over time.

Moreover, complexity and cost of the apparatus are reduced since the need to use sliding-contact and/or movable-contact connections is completely avoided.

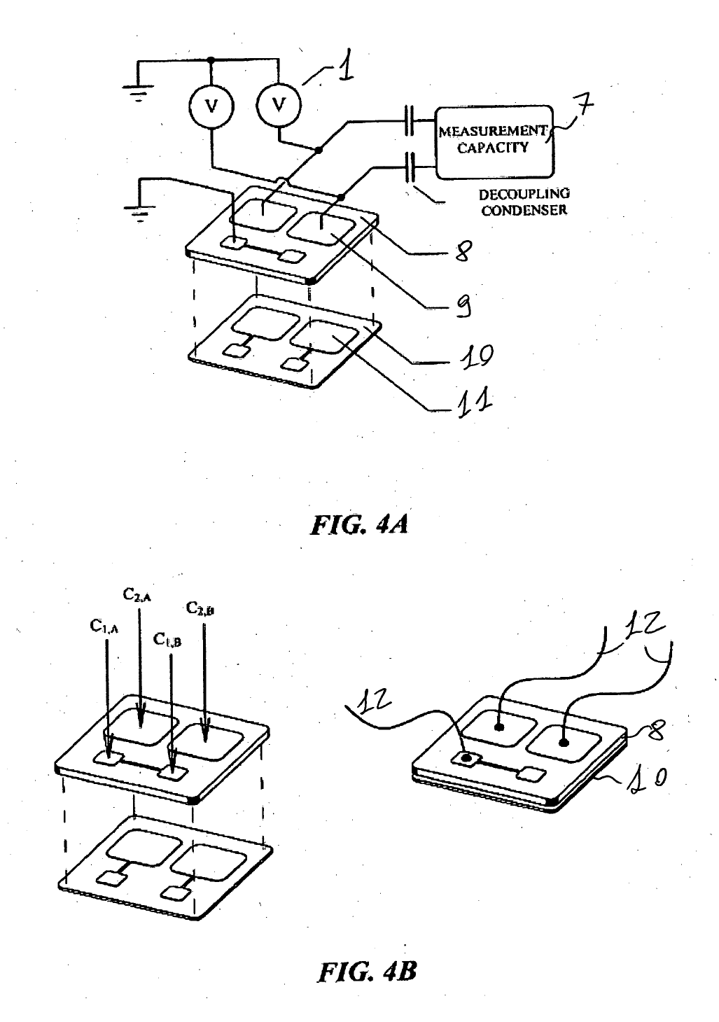

With reference to FIGS. 4A and 4B, these show a scheme of a denaturing cell realized according to the differential system of the present invention. For illustrative clarity, the same parts will have the same numbers and their detailed description will be omitted here since it was already provided above.

According to the invention, the cell has a pair of voltage generators 1 electrically connected to a capacity measurement circuit 7 realized as described above. The cell 6 has a first support 8 made of ceramic material or similar material with a high ∈ᵣ on which metal electrodes 9 are placed. The coupling between ceramic support and metal electrodes is realized according to techniques currently well known. Then, a second support surface 10 is involved, which bears functionalized areas and in which the respective gold electrodes 11 are fixed by means of a well known technique such as for instance sputtering or similar techniques.

Then, in reference to FIG. 4B, the cell is assembled as a sandwich in such a way that the electrical contacts 12 present on the cell are fixed and are external to the volume of the cell containing the solution. Therefore, they are free from wear and corrosion phenomena and problems deriving from erratic contact resistance values.

Several algorithms (usually containing one or more iterative procedures of choice) can be used to dimension the microfluidic cell.

For instance, it is possible to perform the following iterations:
1. Definition of the capacity of condensers C_{1,A} and C_{1,B}: it is performed based on the characteristics of the capacity measurement system. In general, in order to optimize the sensitivity (resolution) of the proposed system, it is convenient to operate near the upper limits of the admissible reading range.
2. Definition of the aspect ratio of the condensers, in order to restrain within acceptable limits the entity of the electrical field dispersed near the edges of such devices.
3. Calculation of the thickness d_{A} of the microfluidic channel, performed taking into account the choices made in 1 and 2.
4. Check of the thickness d_{A}: it should be considered that, with a decrease of this value, the difficulties in realization of the cell and the risk of air bubble entrapment inside the cell increase. However, with the decrease of d_{A}, there is the advantage of a reduction of the total size of the working volume, with consequent better possibility of miniaturization of the system. The tests made indicate that the minimum acceptable d_{A} values are comprised within the range of 100-500 m. Two conditions can occur:
   The value obtained for d_{A} is higher than the preset minimum value: in this case the general dimensioning of the system can be considered complete.
   The value obtained for d_{A} is lower than the preset minimum value: in this case it is possible to increase the d_{A} to the minimum value and to calculate the value of the surface area of the armors in a way that the capacity of the condenser remains as decided in 1. The resulting value will be lower than that defined in 2, however, this is the maximum that can be obtained under the conditions described. If this situation is unacceptable, it is possible to increase, if allowed, the capacity value fixed in 1. It may be necessary to reconsider the capacity measurement system.

### Example of Embodiment

The analogic-digital converter AD7744 of Analog Devices, usable as system for capacity measurement, is able to make measurements on condensers of maximum value up to about 15 pF.

Therefore it is possible to fix:

C_{1,A}=C_{1,B}=10 pF

Assuming to use condensers with square shape armors, with side L, the aspect ratio can be defined as:

$$η = \frac{L}{{d}_{A}}$$

Fixing equal to 10, it follows that:

$$C = {ɛ}_{0} {ɛ}_{r} \frac{A}{{d}_{A}} = {ɛ}_{0} {ɛ}_{r} \frac{{L}^{2}}{{d}_{A}} = {ɛ}_{0} {ɛ}_{r} {η}^{2} {d}_{A} ⇒ {d}_{A} = \frac{C}{{ɛ}_{0} {ɛ}_{r} {η}^{2}}$$

### Therefore:

$${d}_{A} = \frac{1 e - 11}{{10}^{2} * 8.85 e - 12 * 80} = 1.41 e - 4$$

The resulting value for d_{A}, equal to 141 m, can be considered acceptable, thus the dimensioning can be considered complete.

Based on the above, it can be asserted that the attainable value of aspect ratio increases with the capacity value fixed in 1, thus improving system accuracy.

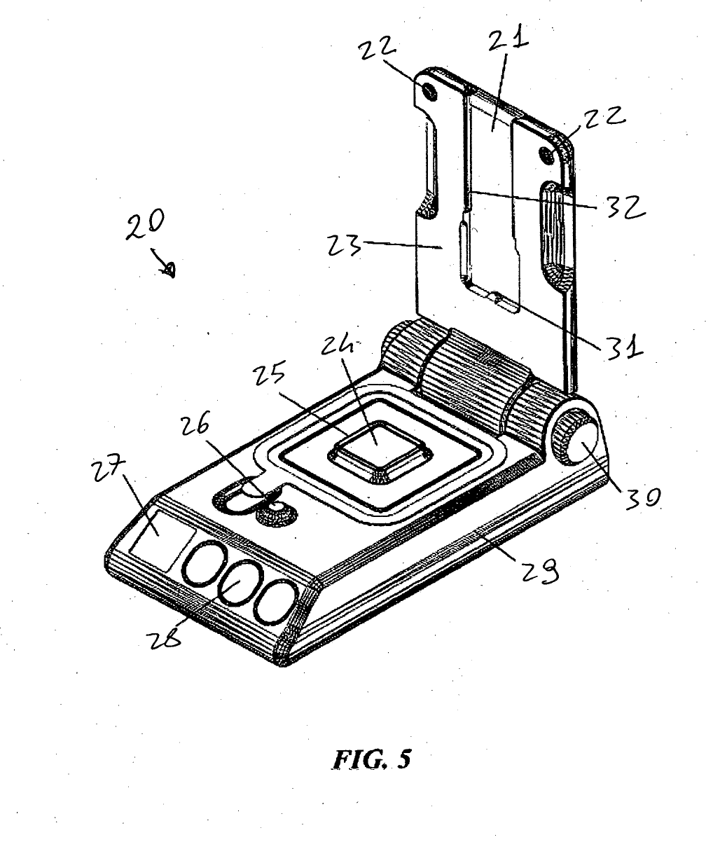

With reference to FIG. 5, this illustrates an example of embodiment of the microfluidic cell according to the present invention. According to the invention, the cell is mounted on a first device 20 with a body 29 on which is mounted a revolving door 23 on an axis 30. The door 23 has a fissure 21 for the insertion of a second disposable device (not shown in the figure) equipped with functionalized surfaces or active areas facing towards the microfluidic cell (better shown below). The fissure 21 has a checking element 31 and the respective guides 32 for correct positioning of the disposable device in the cover 23.

Moreover, the embodiment provides for the presence of fixed spacers 22 for correct positioning of the disposable device in the microfluidic cell 6, to be placed on door 23. In fact, when door 23 is closed, these fixed spacers 22 allow to automatically define the distance “d_{A}” from the denaturing cell. At the central part of the body 29, the embodiment provides for the presence of a surface 24 circumscribed by a silicon gasket 25. The surface 24 and the gasket 25 correspond to a fixed wall of the microfluidic cell 6. The microfluidic cell 6 is formed when the cover 23 is closed, and has a near parallelepiped shape. The larger walls of cell 6 are formed respectively by surface 24 and the respective portion of the surface of the disposable device (not shown in the figure) when this is inserted in the corresponding fissure 21. The side wall of the cell, having a height dA, is formed by the silicon rubber gasket 25. Surface 24 is realized in ceramic material with a high value of relative dielectric constant, as previously described. Electrodes are placed inside the body 29 of the apparatus. Gasket 25 and surface 24 define the walls of the well in which the test solution is placed.

On the other hand, the embodiment provides for the presence on body 29 of a blocking magnetic device 26 in order to block the cover 23 in closed position. At the frontal part of the body 29, the embodiment provides for the presence of a liquid crystals display 27 to visualize the status of the instrument and the results of the analysis and for a hermetic keyboard 28 to control the instrument, based on the use of capacitive sensors.

The so realized analysis device has a small size, is simple, practical and highly reliable, offers the possibility of a thorough cleaning of the working volume by means of washing solutions and, when possible, by autoclave sterilization. The microfluidic cell can be completely opened and therefore can be easily inspected and washed.

The whole instrument is hermetically sealed, such that it can be conveniently immersed in a washing solution or sterilized by autoclaving. The so realized analysis device makes possible to perform the analysis in stand-alone or computer-connected mode. In the latter case, the transfer of information between the two devices can be realized, for instance, by a radiofrequency communication system or via cable. The electrical energy required for instrument operations is supplied by a lithium battery placed inside body 29. The battery is recharged by a control circuit capable of receiving energy through a system based on inductive coupling. This way, the presence of openings on body 29 is unnecessary. The body 29 and the cover 23 of the instrument can be realized with polymeric material, typically ABS or polycarbonate.

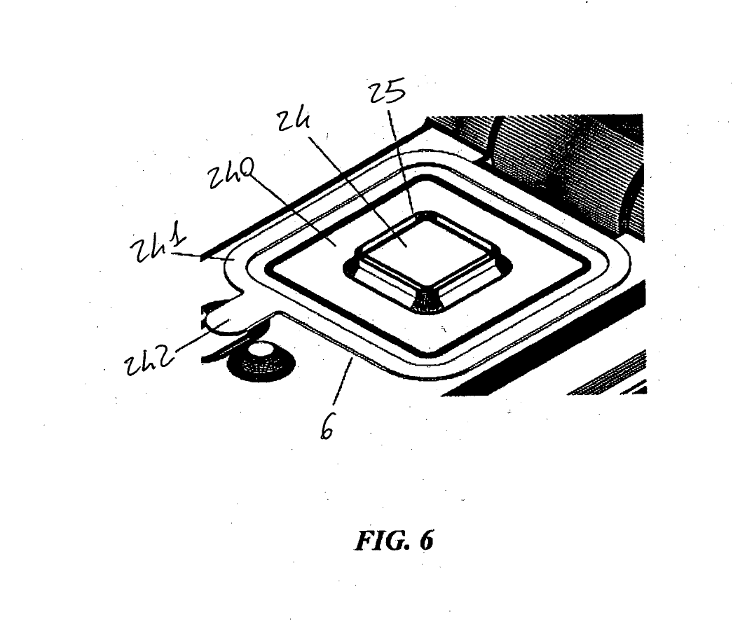

With reference to FIG. 6, this illustrates in detail the part concerning the denaturing cell 6 obtained on device 20. As it is more clear in the figure, the body 29 has a central cavity wherein the region of surface 24 has been obtained, that is bounded by gasket 25. Together they form a well that accommodates the test solution and at the same time forms the perimetral wall of the microfluidic cell 6. Moreover, the embodiment provides for the presence a region 240 that accommodates the volume of a test solution exceeding the capacity of the microfluidic cell 6. Also in this case, the embodiment provides for the presence of a silicon rubber gasket 241 that is removable and replaceable, and is equipped with a flap 242 for removal of the rubber gasket 241.

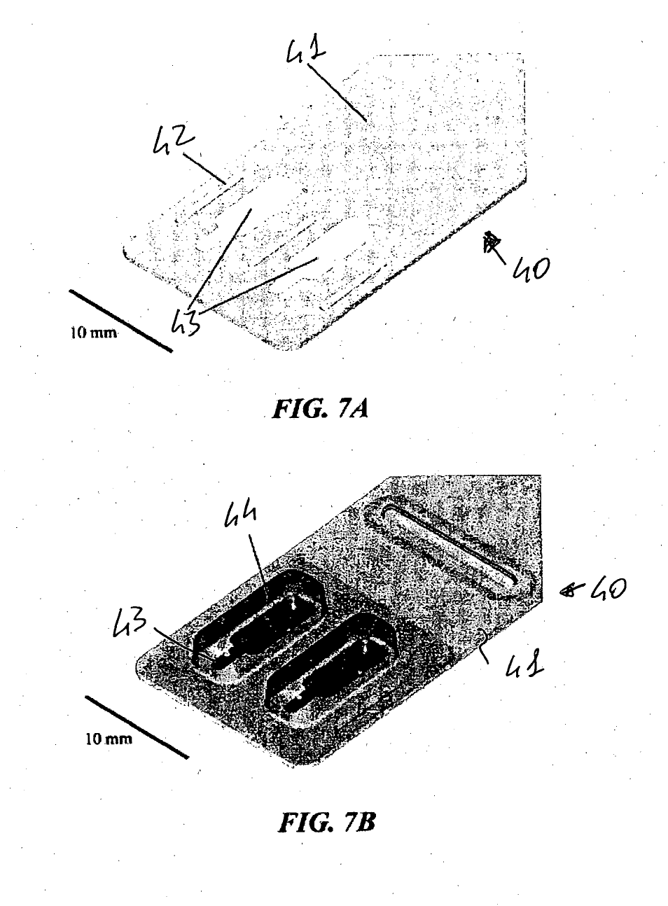

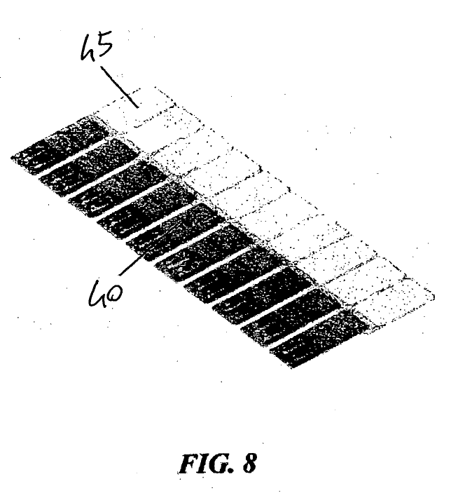

With reference now to FIGS. 7A and 7B, there is shown a form of embodiment of the second disposable device for providing the support to the functionalizing areas of the denaturing cell 6, and according to the system of the present invention.

More specifically, and with reference to FIG. 7A, the embodiment provides for the presence of a support element 40 suitable to be inserted in fissure 21 of cover 29 by sliding on grooves 32, and blocked there. As it is clear in the figure, support 40 is preferably realized with a strip 41 of polymeric material (e.g. PET of 350 m thickness) obtained by die-cutting. The embodiment provides for the presence on the surface of stiffening ribs 42, placed near the respective functionalizable areas 43, in order to improve geometrical tolerance of the microfluidic cell. Areas 43 are obtained by gilding in a vacuum chamber (magnetron sputtering system). The gold layer surface is free of contaminating substances due to an oxygen plasma cleaning treatment following metal deposition. It is appropriate to point out here that the geometry represented in the figures is purely indicative.

With reference to FIG. 7B, this illustrates the second device 40 once it is assembled in a blister shape. As it is possible to understand from the figure, the embodiment provides for the presence, in the areas of functionalization 43, of thermoformed capsules 44 designed to contain the solution and to activate the above-mentioned functionalizable areas 43 that are present.

The blister depicted is realized by a vacuum thermoforming system starting from a film of thermoformable and thermosealable polymeric material, with a high barrier effect, for instance having 100-350 m thickness. For instance, it is possible to use a film composed by two coextruded-layers of PVC and PE. In order to avoid contaminations, the inner surface of capsules 44 is subjected to a cleaning treatment by plasma oxygen at atmospheric pressure.

Capsules 44 of the disposable device are filled with a solution suitable for functionalization of the active areas (e.g.: synthetic oligonucleotides functionalized by means of a spacer group C₆ and a thiol —SH group).

The so realized device 40 shows a considerable advantage deriving from the fact that device activation occurs after sealing the capsules containing the functionalizing solution, during a short storage period in normal ambient conditions. In fact, the functionalizing reaction proceeds inside the blister without requiring the use of suitable reaction environments, with considerable reduction of production times and of the amounts of necessary reagents. Moreover, this way it is possible to exploit the times of product storage and transport to obtain a sufficient advancement of the functionalization reaction.

A further advantage is in the fact that the active areas 43 are protected until use. In absence of functionalizing solution, the same type of packaging can be used for transport and marketing of supports 40 perfectly cleaned by the plasma treatment. This way, it is possible to save the final user from doing the surface cleaning process, thereby accelerating and simplifying the laboratory procedures.

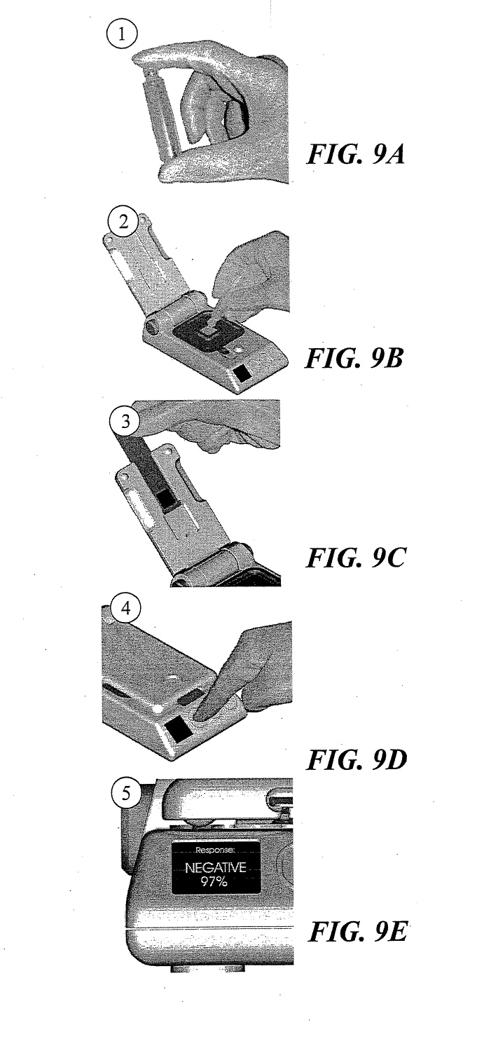

With reference to FIG. 8, this illustrates an arrangement of device 40 of the present invention. More specifically, as can be noted in the figure, it is possible to realize a blister composed of a multiplicity of units 40 as single pre-die-cut devices, for packaging and sale. According to the present invention, each unit consists of a device 40 which has integrally an area 45 for labeling and handling of disposable devices 40.

With reference to FIGS. 9A and 9E, these illustrate the sequence of operations for the use of the analysis system of the present invention. More specifically, the procedure involves a first phase of sampling of the test solution (FIG. 9A). The solution is subsequently loaded in well 24 of device 20 (FIG. 9B). Any exceeding solution is not dispersed due to the presence of the secondary containment well 240 obtained inside the silicon rubber gasket 241. The second disposable device 40 is then inserted in the suitable fissure 21 obtained on cover 23, with active areas 43 oriented in a way that they are always visible to the operator (FIG. 9C). Obviously, before use, the operator should remove the protection blister 44 and remove the solution contained in it. In order to avoid mistakes, the correct way of insertion is codified by the geometry of the disposable device 40.

Cover 23 of the analysis device 20 is then closed thereby resulting in formation of the microfluidic cell 6 (FIG. 9D). In this condition, the automatic analysis procedure is started. At the end of the analysis, the analysis device 20 provides the result in synthetic format on the display 27 (FIG. 9E).

Further advantageous aspects of the system of analysis of the present invention should be emphasized here. A first advantageous aspect derives from the fact that, so far, a sequence of operations of the analysis device 20 relative to a stand-alone operating mode has been described, that is without support of additional electronic and/or data processing systems, although the device can be interfaced with such systems to provide more data to the operator.

Another advantage is in the fact that the analysis device 20 can be provided with a system for the reading of the bar code present on the disposable device 40, in order to identify the type of ongoing analysis and provide a correct evaluation of the results. Alternatively, the operator will be able to insert a code of the analysis from the keyboard 28. The reading device is equipped with a non-volatile memory unit in which the information necessary for the evaluation will be subsequently stored. This database can be updated through cable or radio connection to a personal computer (e.g., Bluetooth protocol).

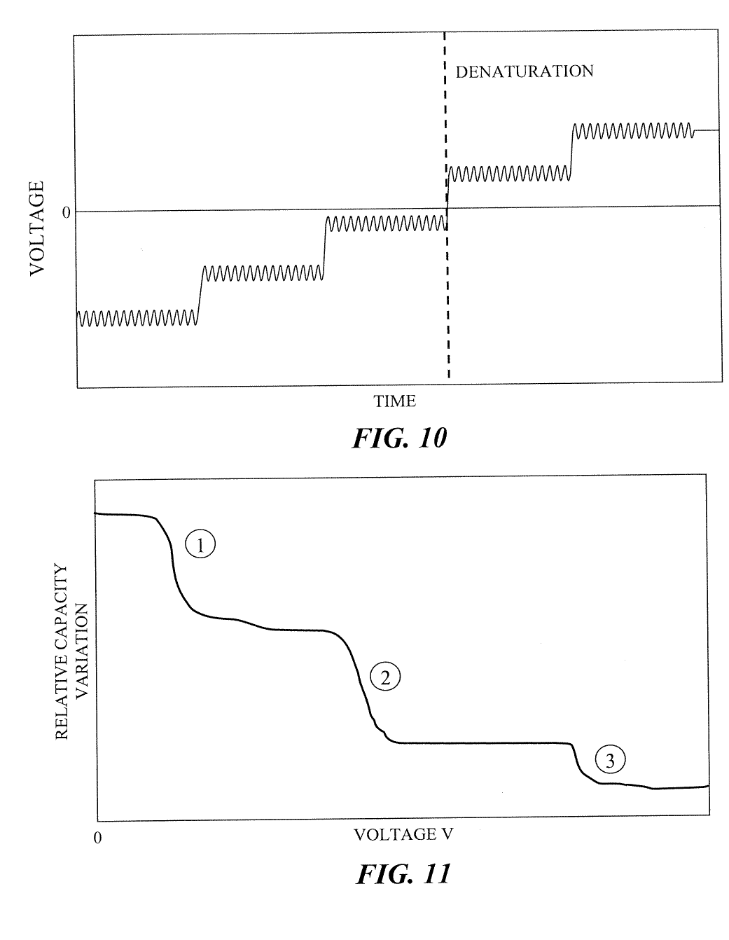

According to another advantageous aspect of the present invention, the proposed procedure of analysis consists in the determination of the denaturation curve induced by the electrical field, by a capacitive type of reading. As described above, due to the solutions provided, the determination of capacity by systems in alternate voltage can be performed in concomitance with the application of a continuous or slowly variable potential to the ends of the microfluidic cell. The latter is useful to induce or facilitate hybridization and denaturation reactions and to promote the electrophoretic transport of charged molecules inside the working solution. Therefore, the voltage measured at the ends of cell 6 can be schematically represented according to the scheme in FIG. 10. In the case shown, the voltage applied by the voltage generator 1 has a step-wise trend that increases with time from negative to positive values. In this case, in condensers C_{1,A} e C_{1,B}, where most of the voltage drop occurs, there is a transition from conditions favouring the hybridization reaction to conditions that promote electric field-induced denaturation. The visible alternate signal (the time scale is obviously indicative) is the one used to measure the differential capacity of cell 6. Minimal and maximal voltage values should be chosen in a way that makes possible to carry out the reactions considered.

According to another advantageous aspect of the system of the present invention, it is possible to change the voltage V in a continuous or near-continuous mode, by using analogic systems or digital-analogic converters with the opportune solution.

FIG. 11 shows a schematic representation of an electrical field-induced denaturation expressed as relative variation of the capacity of the system.

When compared with the curve obtained from the analysis of a reference system, this curve can be used, for instance, for identification of specific gene sequences or for detection of possible mutations in a known gene sequence. As an example, three steps identified by the numbers (1), (2) and (3) are visible in the scheme shown in the figure; these are due to three distinct denaturation processes activated by increasing values of the electrical field. They can be due to the use of three different molecular probes for the functionalization of the active areas 43 of the disposable device. The height of each step and its position can provide useful indications about the characteristics of the sequences contained in the solution analyzed. In particular, it is possible to increase the amount of attainable information by using different molecular probes for:
Number of bases present in the sequence.
Use of modified bases inside the sequence (e.g. PNA, LNA, etc.).
Modifications at one or both ends of the chain.
Control of the spacing of molecular probes on a functionalized surface (steric effect).

Another advantageous aspect of the system of analysis of the present invention is in the fact that it makes possible to avoid the use of arrays of functionalized areas or to reduce considerably (e.g. by a factor of 10) the number of areas required for a given analysis. In fact, the system of the present invention, in addition to a classical exploitation of two space dimensions for realization of the sensor array, allows for a further level of freedom consisting in the voltage used to promote denaturation reactions.

1. A method for the detection of nucleic acid oligonucleotides, said detection being obtained by a capacitive reading of the melting point of complexes obtained by hybridization of said oligonucleotides and suitably modified molecules of oligonucleotide probes, wherein said melting is induced by application of an electrical field generated in a solution containing said oligonucleotides and said suitably modified molecules of oligonucleotide probes, wherein said capacitive reading is decoupled from the continuous voltage component applied for hybridization.

2. A method for the detection of nucleic acid oligonucleotides, according to claim 1 comprising the following steps:
introducing in a microfluidic cell a solution containing a sample of oligonucleotide molecules to be detected;
introducing in said microfluidic cell a sample of said oligonucleotide probe molecules suitably modified and immobilized on a supporting surface;
applying a predetermined electrical field (V) to said microfluidic cell in order to control hybridization and denaturation reactions of unknown nucleic acid sequences present in said solution and with said oligonucleotides immobilized on said supporting surface; and
continuously monitoring of the progression of the reactions by a capacitive reading of said microfluidic cell.

3. A method for the detection of nucleic acid oligonucleotides, according to claim 2 comprising a further step of providing said microfluidic cell of a first and second dielectric, and obtaining a ratio from the first dielectric A and the second dielectric B, d_{A}/d_{B}, comprised from 1 to 2.

4. A microfluidic cell for the detection of nucleic acid oligonucleotides in a solution, said detection being obtained by means of a capacitive reading of the melting point of the complexes formed as result of the hybridization of said oligonucleotides with suitably modified molecules of oligonucleotide probes, wherein said microfluidic cell comprises:
at least one voltage generator electrically connected to a circuit for the measuring of a capacity value of said solution;
at least a first support realized with material having a high ∈r, and having at least a couple of metallic electrodes fixedly mounted thereon;
at least a second supporting surface having functionalized areas and where respective electrodes made of a noble metal are fixedly mounted onto said supporting surface; and
at least a condenser C_{block} for decoupling the continuous voltage component of the working cell from the capacity reading system.

5. A microfluidic cell according to claim 4, wherein the geometry of said microfluidic cell is suitable to obtain a ratio from a first dielectric A and a second dielectric B, d_{A}/d_{B}, comprised from 1 to 2.

6. A microfluidic cell according to claim 5, wherein said functionalized areas are supported in a device comprising:
a strip made of polymeric material such as PET or similar; and
a plurality of functionalizing areas each containing said modified molecules of nucleic acid oligonucleotide probes immobilized therein, the arrangement defining the geometrical tolerance of said microfluidic cell.

7. A microfluidic cell according to claim 6, wherein said functionalizing areas comprise a noble metal applied by sputtering or similar procedure.

8. A microfluidic cell according to claim 7, wherein said device further comprises capsules being thermoformed at said functionalized areas and for the containing of a functionalizing solution for functionalizing said areas.

9. A microfluidic cell according to claim 6, wherein said device is in a blister shape obtained by a vacuum thermoforming of a film of a thermoformable and thermo-sealable polymeric material.

10. A microfluidic cell according to claim 8, wherein said functionalizing solution contained in said capsules comprises functionalized synthetic oligonucleotides.

11. A microfluidic cell according to claim 10, wherein said synthetic oligonucleotides are functionalized by at least one C₆ spacer group and a thiol-SH group.

12. A microfluidic cell according to claim 8, wherein said functionalizing of said areas is obtained after the sealing of said capsules containing said functionalizing solution.

13. A microfluidic cell according to claim 8, wherein said areas are protected by said capsules in absence of functionalizing solution.

14. A blister comprising a plurality of devices according to claim 6, wherein each device further comprises integrally a region for the labelling and the handling of said device.

15. A blister according to claim 14, wherein each device is disposable.

16. An apparatus comprising a microfluidic cell according to claim 5, wherein it comprises:
a main body having a swinging cover rotatably mounted on an axis;
a region for the housing of said device;
a surface having a silicon gasket or similar at the central part of said body, and wherein said surface and said gasket correspond to a first fixed wall of said microfluidic cell and said device constitutes a second fixed wall of said cell when said cover is in the closed condition.

17. An apparatus according to claim 16, wherein said surface is realized with a material having a high value of dielectric constant, such as a ceramic material or similar.

18. An apparatus according to claim 16, further comprising:
a blocking device to block the cover in a closed position;
a display at a frontal part of said body; and
a keyboard for the control of said device.

19. An apparatus according to claim 16, further comprising a rechargeable battery housed inside said body, said recharge operation being obtained through a system based on inductive coupling.

20. An apparatus according to claim 16, wherein said detection of nucleic acid oligonucleotides is obtained through a stand-alone mode or interfaced with a computer or similar.

21. A system for a genetic pattern recognition, comprising an apparatus and a device according to claim 16.
